(19) United States
(12) Patent Application Publication
(10) Pub. No.: US 2008/0263009 A1
(43) Pub. Date: Oct. 23, 2008

(54) System and method for sharing of search query information across organizational boundaries

(76) Inventors: Raymond R. Buettner, Seaside, CA (US); Stephen D. Donald, Bowie, MD (US); Robert McMillen, Wimberley, TX (US)

Correspondence Address: WHITEFORD, TAYLOR & PRESTON, LLP;ATTN: GREGORY M STONE, SEVEN SAINT PAUL STREET, BALTIMORE, MD, 21202-1626, US

(21) Appl. No.: 11/788,289

(22) Filed: Apr. 19, 2007

(51) Int. Cl. G06F 17/30

(52) U.S. Cl. 707/3; 707/E17.108

(57) ABSTRACT

Disclosed is a method and system for capturing and reporting information relating to an organization's queries, such as Internet search queries generated by particular groups within an organization, and making such information available to others to support various decisions organizations must make. The search activity of search-level users may be constantly tracked, and search event data records (including query terms and an identification of the search-level user) are collected and analyzed. An analytics engine receives and analyzes the search event data and determines when predefined organization-specific relationships exist between queries of distinct users. When such a relationship is identified, a notification message or alert may be generated indicating the existence of such relationship, and directed to a person in the organization other than the search-level users whose queries were found as relating to one another, thus allowing such person receiving the notification to take action in response to the related activity.

### FIELD OF THE INVENTION

The invention disclosed herein relates to automated systems and methods for knowledge extraction to inform business and management decisions, and more particularly to methods and systems for capturing and reporting information relating to relationships among queries generated by an organization's members, such as queries used to search for information on the Internet, in proprietary data stores, or files in computer software programs (e.g., database programs, word processing programs, etc.), and the like, which queries are generated by particular groups within an organization, and making such information available to others to support various decisions organizations must make.

### BACKGROUND OF THE INVENTION

Various organizations have continuous needs to search for, locate, and assimilate information relating to topics of interest for such organizations. Computer systems and computer implemented applications are often utilized to assist users in locating such information. For example, members of an organization may craft and use search queries in a commercially available search engine, such as GOOGLE, in an effort to locate information relating to their particular topic of interest. Likewise, such members of an organization may craft and use search queries in “find” or “locate” functions within a computer software program, such as a database program, spreadsheet program, word processing program, organizational network, or the like, to locate information relating to their topic of interest.

Efforts have been made in the past to assist such members of various organizations to locate information relating to their topic of interest. More particularly, efforts have been made to examine user queries and to connect those queries to the particular information being sought, to in turn minimize the effort that a searcher must expend in retrieving information relevant to their topic of interest. In many instances, queries are studied and statistics developed that aggregate search data, treating the individual member of the organization as a “generic searcher,” as a way of measuring how often a search engine is used or what topics are of interest to generic users of a specific search engine or Internet web site. The objective of such techniques is typically to improve search performance, i.e., providing a more efficient search result. Often such methodologies link the user's query to the most common result produced for that and similar queries, and display such result to the user. Thus, such tools have focused on how to connect the user's particular query to the specific information being sought by such user.

Study has also been undertaken to assist members of various organizations seeking specific information by exploring institutional knowledge of the organization, and using such institutional knowledge as a resource for such members. An organization's “transactive memory,” or a map of where specific knowledge or expertise lies within an organization, allows members of the organization to transact with each other to find the specific information they are seeking. An organization's transactive memory focuses on who knows what information, and thus provides members of the organization the resource to tap when specific knowledge in a specific area is required.

Unfortunately, in each of these cases, utility is largely limited to retrieving information to answer a specific question from a member of the organization. However, much value is to be obtained through an understanding of who within an organization is seeking what information, i.e., the broader knowledge-seeking behavior of an organization. Rather than focusing on the specific information that best meets a user's query, or the best resources available to meet the user's query, it has been found that evaluating an organization's search query behavior by aggregating search query data across users within the organization can inform management in such organizations of important opportunities and threats, achievement of and compliance with business and/or mission goals, and various other issues that are not evident merely by review of specific answers to user queries. Thus, it has been found that aggregating queries across an organization may produce new, previously undiscovered knowledge of value to that organization.

For instance, while previous efforts have been made to inform one searching entity that their query might topically relate to another searching entity's query, the existence of a relationship between those queries is reported only to those searching entities. However, knowledge of the existence of a relationship between the queries of two disparate searching entities may be highly valuable information to a third party, such as a supervisor within an organizational structure of which both searching entities are members. For instance, each of the searching entities may be employees in separate working divisions of a company, and each may be investigating the scientific properties of a new material that has potential uses in a new product to be launched by yet another division of the company. The fact that disparate users are investigating such common subject matter, or subject matter relating to a particular topic of interest to the organization, may be valuable information to a new product development manager that oversees each of those divisions; however, to maintain the secrecy of the details of the new product that is yet to be launched, the searching entities in separate divisions of the company are unaware of the existence of the new product development, and thus of the relevance of their research to that project. While prior technologies could allow the two independent searching entities to discover that each of them is looking into a specific material, their lack of knowledge of the secret new product development will result in them failing to realize the importance of such information, and the importance of the relationship between their respective queries to their organization as a whole. Thus, in effect, the independent searching entities are unable to fully “connect the dots” between their independent research and the objectives of the organization as a whole; however, if the supervisor had knowledge of their independent research efforts into such new material, that knowledge could lead the supervisor to direct employees working on the new product project to either begin investigating use of such new material, or even collaborate with the searching entities on the new product development project. The lack of a mechanism to allow the third party supervisor to realize a relationship between the research efforts of various members of his organization, and the lacking knowledge of the disparate searching entities in his organization of the importance of a query relationship to their organization as a whole, result in lost opportunities to fully exploit such information and such organizational knowledge.

Thus, there remains a need for methods and systems to allow for the discovery of relationships between queries of disparate members of an organization, and between one or more members' queries and subjects of interest to the organization, which member queries may be input to Internet search programs, database programs, word processing programs, proprietary data stores, or any other searchable data collections, that can create new organizational knowledge to support various decisions that an organization must make. As used herein, the term “organization” is used in its broadest sense, and could be anything from a broad community of interest to a two-person partnership with defined roles.

### SUMMARY OF THE INVENTION

Disclosed herein is a method and system for capturing and reporting information relating to an organization's queries, such as Internet search queries, database or word processing program queries, file system queries, etc., generated by particular groups within an organization, and making such information available to others to support various decisions organizations must make.

In accordance with one aspect of a particularly preferred embodiment, the search activity of search-level users is constantly tracked, and search event data records are collected and analyzed. Such search event data records preferably comprise at least a timestamp (i.e., the time at which a given search was created), the query terms, and an identification of the search-level user, which identification includes at least an indication of the individual's role within the hierarchy of the particular organization. An analytics engine receives and analyzes the search event data and determines when correlations exist between queries of distinct users and/or between one or more users' queries and subjects or topics that are of particular interest to the organization. When a correlation is identified, a notification message or alert may be generated indicating the existence of such correlation. The correlation criteria is preferably defined by an administrative user of the system, and particularly by someone other than the search-level user or users whose search event data records are being compared. Such correlations may identify, for example, top queries by particular groups within the organization, novel queries by particular groups within the organization, query trends within defined segments of the organization, query waves (i.e., large trends) across multiple segments of the organization, queries occurring in high and/or low frequency across the organization, repetitive or “deep” searches by particular individuals or groups within the organization, organization-defined high interest or low interest queries, and the like.

Thus, according to one aspect, the present invention provides a method of identifying correlations among search queries by disparate users within a structured organization, for example an organization having a defined hierarchy, in which data is received from a first user identifying the user and at least one query generated by the user, such query is compared with a search term of interest (whether that term is a matching or related query by another user or a search term designated by the organization as having some particular relevance or interest) to determine whether a correlation exists between them, and if a correlation exists, a third party user distinct from the first user is notified of the existence of such correlation.

Moreover, according to another aspect, the present invention provides a system for identifying and reporting correlations among search queries by disparate users within a structured organization, the system having a plurality of search event data records from a plurality of search users stored in at least one database, the search event data records each having a timestamp, one or more query search terms, and an identification of the search user generating the query search terms, one or more search user devices in data communication with the database and configured to transfer search event data records to the database, and a computer processor in data communication with the search user client devices and the database, in which the computer processor has executable computer code that is adapted to compare a plurality of search event data records in the database to determine whether a predefined organization-specific relationship exists between query search terms in the search event data records, and generate an electronic notification of the existence of any predefined organization-specific relationships determined to exist, and forward the electronic notification to one or more administrative users. The electronic notification may be customized for the administrative user based upon the position or role of the respective administrative user of such device within the structure of the organization.

### BRIEF DESCRIPTION OF THE DRAWINGS

Other objects, features, and advantages of the present invention will become more apparent from the following detailed description of the preferred embodiment and certain modifications thereof when taken together with the accompanying drawings in which:

FIG. 1 is an exemplary illustration of a system implementing a transactive inquiry method in accordance with a first particularly preferred embodiment of the invention.

FIG. 2 is a schematic representation of the relevant data fields in the appliance data store of FIG. 1.

FIG. 3 is a schematic representation of a method carried out by a search data correlator in order to determine whether a correlation exists among user queries.

FIG. 4 is an exemplary user interface screen that may be presented to an administrative user to allow such user to modify the permissions of other users of the system.

FIG. 5 is an exemplary control center user interface screen that may be presented to a user to allow them to access and control various functions and data for reviewing, managing, and reporting on correlations.

FIG. 6 is an exemplary alert screen that may be presented to a user.

### DETAILED DESCRIPTION OF THE PREFERRED EMBODIMENTS

The invention summarized above may be better understood by referring to the following description, which should be read in conjunction with the accompanying drawings. This description of an embodiment, set out below to enable one to build and use an implementation of the invention, is not intended to limit the invention, but to serve as a particular example thereof. Those skilled in the art should appreciate that they may readily use the conception and specific embodiments disclosed as a basis for modifying or designing other methods and systems for carrying out the same purposes of the present invention. Those skilled in the art should also realize that such equivalent assemblies do not depart from the spirit and scope of the invention in its broadest form.

Disclosed herein are methods and systems for evaluating organizations' queries through a transactive inquiry process to create new organizational knowledge that can be used to support various decisions. The transactive inquiry process creates new knowledge by comparing two or more transactive inquiry sets (each set comprising at least an inquiry and an identifier for an inquirer, as discussed in greater detail below) in a specified organizational context to produce new knowledge over time. More particularly, the transactive inquiry process relates transactive inquiry data sets preferably comprising the query platform, the query itself, and the user (and particularly the user's role within the hierarchy of an organizational entity) to create organizational knowledge based on the queries themselves, and not on the search query results. The behavior of knowledge workers in an organization may thus be classified as transactive inquiry events, and those events may be collected, aggregated, and analyzed to create the opportunity for new understanding of organizational attributes relating to how an organization searches for information. This information may in turn be used to inform business decisions through identification of various opportunities, threats, compliance with business goals and objectives, and other business and strategic issues that an organization must address. Although an organization may have a complex organizational construct with various departments, divisions, and agencies, the transactive inquiry process may transcend such organizational obstacles to inform leadership of new challenges and opportunities.

For example, the transactive inquiry process may provide market intelligence by, for example, allowing a manager of a software development firm to learn that such firm's software engineers are all interested in a particular software product that a competitor has just released. Likewise, the transactive inquiry process may improve a company's process efficiency and effectiveness at meeting training requirements by, for example, informing the company's management that the company's in-house database is not a good investment because the company's Technical Support Department is commonly searching a commercial search website, such as GOOGLE, for subjects it should already contain. The transactive inquiry process may also improve a company's process efficiency, goal congruence, and communications effectiveness by informing the supervisor of a department having many related queries of whether the entire team is focused on similar subjects and whether those subjects are appropriate given the priorities of such department. Such process may even further be used to identify related queries by disparate entities, such as (in the case of the terrorist attacks of Sep. 11, 2001) allowing management personnel or individual users in each of the FBI and CIA to know that analysts in each have become curious about “terrorist flight schools” and “Al Qaeda” and have searched several data repositories and the Internet for such terms. The transactive inquiry process thus creates knowledge that preferably empowers management to monitor and improve market intelligence, information technology performance, training, process efficiency, goal congruence, customer service, and management performance beyond the capabilities of prior knowledge management and automated search methods and systems.

The transactive inquiry method is not based on the simple counting of queries such as a GOOGLE or YAHOO TOP SEARCH list, which are merely tabulations of search terms sent to a specific search engine. Rather, transactive inquiry looks across the spectrum of search technologies within an organization to discover knowledge in the context of the organization. Thus, the transactive inquiry process will investigate queries generated by searching entities when performing online searches on the Internet (such as through the use of any one of the widely known commercial search engines, such as GOOGLE, YAHOO, etc.), searches through internal and/or third party databases, searches in various applications (such as email and word processing programs), and any searches, whether in or against classified or unclassified data sources, in which the subject matter comprising the query can be collected and compared to other queries.

While the study of search engines and processes is a relatively new field, such study has essentially focused on providing answers or search results. For example, a “Personalized Search” function from GOOGLE only applies history to focus results. The transactive inquiry method, however, derives values from the queries themselves and their relationship to the organization and/or its personnel.

With regard to a preferred embodiment of the invention, the transactive inquiry method and a system employing such method provide transactive inquiry data to an organization to create business value in the form of corporate intelligence. This intelligence is rendered in a series of data relationships that can be used to manage organizational processes and/or achieve organizational objectives. Following is an exemplary list of transactive inquiry relationships, which exemplary list may grow or otherwise adjust to fit the needs of particular applications. Such list may help determine whether work processes are aligned with objectives at all levels of an organization, detect new market opportunities or product quality problems, provide metrics for training and educational programs, and provide beneficial knowledge to managers that is not available with current methodologies. As used herein, “transactive inquiry relationship” refers to any query-derived relationship that includes the query, the query source, and an organizational context or relationship, including but not limited to the following:
Top “X” queries (where “X” is user defined)
   By organization/department/division
   By inquirer
   By query technology (GOOGLE/YAHOO/Database/etc.)
Novel queries (first match identified within “Y” period where “Y” is user defined)
   High interest
   Low interest
   Undefined
Trends (sets of queries originating within an organization within “T” time of each other, where “T” is user defined)
   New trend (a trend that has begun since time “T”)
   Old trend (an ongoing trend that began prior to time “T”)
   Novel trend (a trend not previously identified)
Waves (sets of queries originating across multiple organizations within “T” time of each other, where “T” is user defined)
   New wave (a wave that has begun since time “T”)
   Old wave (an ongoing wave that began prior to time “T”)
   Novel wave (a wave not previously identified)
High frequency (more than “H” matches in “T” time, where “H” and “T” are user defined)
   High frequency low interest (a subset of Top “X”, designated low interest queries)
   High frequency high interest (a subset of Top “X”, designated high interest queries)
   High frequency undefined (a subset of Top “X”, undesignated queries)
Low frequency (fewer than “L” matches in “T” time, where “L” and “T” are user defined)
   Low frequency low interest (designated low interest queries)
   Low frequency high interest (designated high interest queries)
   Low frequency undefined (undesignated queries)
Persistent searches (searches involving multiple sources by the same Inquirers regarding the same subject, which can meet any of the previously defined classes)

The above relationships may be embodied in a series of computer-implemented instructions that generate an alert or other message when such a relationship is identified between or among searches or queries by disparate members of an organization. As likely only some searched subject matter falling within a defined relationship will be of relevance to the strategic business or other decisions of the relevant organization, preferably only those queries that are of particular interest to the organization and that meet one of the defined relationships will generate alerts to designated personnel within the organization, and the administrative users preferably maintain the ability to designate what subject matter is and is not of relevance. Nonetheless, as query data may be collected from all automated search services and tools that members of an organization might use, an administrator or supervisor in such organization may generate reports filtering all query information to identify any of the above described relationships for all such query information as needed for their particular application.

Thus, by way of example, researchers in distinct divisions of an organization may engage their typical automated search tools, generating queries in an effort to identify information of interest to those particular researchers. As described in greater detail below, an automated transactive inquiry client on each of the researchers' computers or other search tools monitors and records the search activity of the respective researcher, such as searches performed on the Internet using commercial search engines, searches for data in database applications, etc. The researchers' queries are continuously collected and analyzed to determine whether and when a transactive inquiry relationship (as described above) is evident in the queries generated by disparate users. When a transactive inquiry relationship between queries is identified, and/or a transactive inquiry relationship between one or more queries and subject matter particularly of interest to the organization is identified, an alert may be generated identifying such relationship to help inform ongoing strategic decisions for the organization. That alert is preferably directed at least to an administrative user positioned within the structure of the organization at a position so as to be able to direct a follow up course of action, such as directing the researches to collaborate in a particular line of research, directing the researchers to change the focus pursued in their research efforts, etc.

While in some instances, it may be useful to alert the researchers themselves to the fact that others within their organization are seeking similar information to that which they themselves are seeking, in certain instances it may be preferable to specifically prevent the researchers from knowing such information, or at least limit the amount of information they have regarding the identity of others searching for similar information. For instance, in certain intelligence situations, one intelligence agency may have the need to maintain secrecy of mission information, including information regarding what researchers in that agency are searching for. Nonetheless, as evidenced by the failure to share intelligence across agency boundaries which many believe contributed significantly to the terrorist attacks of Sep. 11, 2001 in the United States, understanding relationships between what disparate researchers are looking for can be extremely valuable and critical information, even in those environments in which the disparate agencies must maintain mission secrecy. To maintain the mission secrecy of each independent agency, indications of related search activity could be directed to an administrative supervisor in a general intelligence hierarchy, such as the United States Director of National Intelligence. To allow for supervisory review of relationships between search queries of disparate users without necessarily disclosing the existence of such relationship between search queries (and/or while limiting the amount of detail available to the searchers or others regarding the identity of specific originators of such queries), a permissions policy is provided allowing administrative users the ability to determine what details users of the system may be exposed to, based upon their membership in a particular subdivision of the organization (e.g., a specific research branch in a governmental organization, a corporate division of a company, a specific school in a university system). That permissions policy preferably provides for each system user a unique identifier for each user, that user's role within the structured organization (which role might, by way of example only, be defined by a job role such as research analyst, branch supervisor, etc.), and the limitations on each user's visibility of data generated by the system based on each such user's role within the structured organization. Thus, and by way of non-limiting example, a lower level employee user in Division X of Department Y of Company Z may issue a high interest search query matching that of a similarly situated employee user in Division A of Department B of that same Company Z. A higher level employee user in Department B (e.g., a supervisor of the lower level employee in Division A) may receive an alert message indicating that such matching queries have been generated, but the permissions policy can limit the amount of detail provided the higher level employee user in Department B. Thus, for instance, the alert message might identify the specific lower level employee user of that higher level employee user's own Division A, but might inform the higher level employee user only that he or she should contact the head of Department Y, or perhaps the head of Company Z, to inform such other authority of the existence of a matching query or other relationship. Obviously, the particular configuration of what alert messages should be generated for what employee roles within an organizational structure would be established as the administrators of such organization would see fit to service their particular needs.

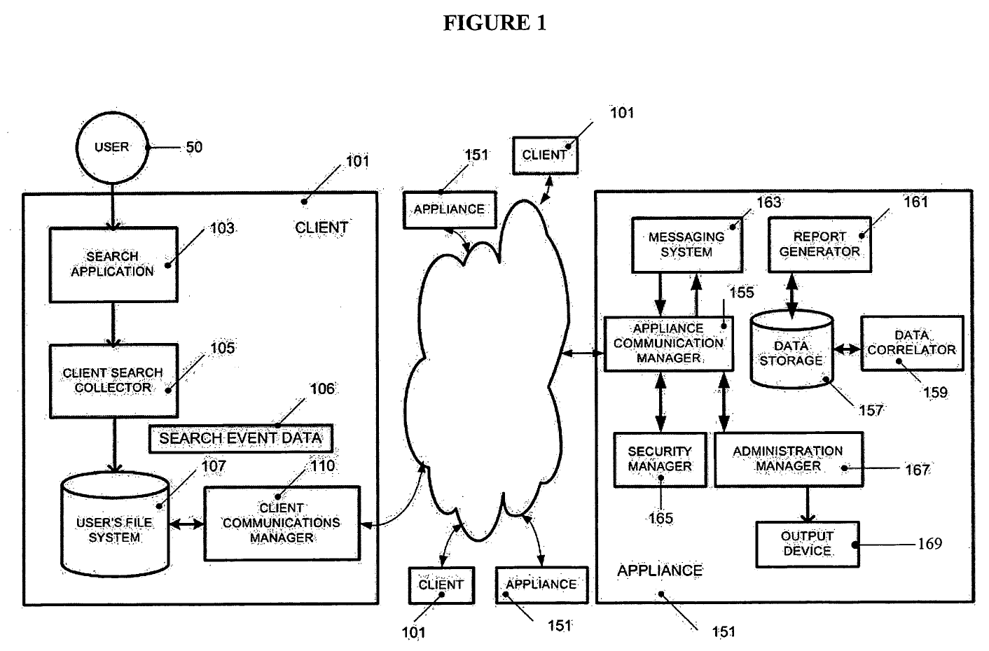

With regard to a particularly preferred embodiment, the transactive inquiry system is implemented through a modular and extensible computer framework for integration that features an integrated secure communications capability allowing easy integration with a variety of browsers, search engines, and other applications utilizing a search function. The system preferably provides a hierarchical reporting and data sharing structure to optimize use of bandwidth and to minimize impact on the user's desktop and network, and maximizes the use of the Internet for interaction with users and managers. Such system provides for secure sharing and analysis of search query information across organizational boundaries. All supported searches are securely relayed to a unit analysis machine where they are aggregated with other queries to provide reporting and alerting as designated by the system managers. The reports provide a means for the organization or unit to know what topics are consuming most of the unit's time and, more importantly, what high interest queries may exist across these boundaries which may warrant cross-unit/organizational contact. FIG. 1 provides an exemplary illustration of a system implementing the transactive inquiry method.

In accordance with a particularly preferred embodiment of the invention, a system employing the transactive inquiry method preferably uses a client device 101 to collect search queries, although queries could likewise be collected via sniffing network data streams or via any other methodology without departing from the spirit and scope of the invention. For instance, instead of providing the exemplary client architecture shown in FIG. 1, when a user enters a search query using online search engines or databases accessed through network connectivity, data passing through the network can be copied by an observant device examining and processing every data packet received regardless of its originating address. Data can be spooled (i.e., reassembled and buffered) and examined for specific data relating to searches, such as URL's, embedded SQL, and other such communications of search events, any of which can be found through data offsets or byte-based (akin to string-based) pattern matching. Thus, by way of summary, search query information may be colleted by capturing data streams wherever they exist (along with the subsequent examination, parsing, and identification of appropriate search related data), or by providing for the cooperative notification and reception of data through hooking of appropriate event notification mechanisms (e.g., plug-ins, extensions, and helper objects). Thus, although for simplicity of discussion the exemplary system set forth herein describes the collection of queries only from browser based sources, such system could likewise collect queries from any query source, including but not limited to desktop applications, database interfaces, etc.

The exemplary system preferably consists of one or more clients 101 and one or more appliances 151 connected through a distributed hierarchy. Although a security mechanism is provided, it is recognized that in some environments it may be appropriate to deploy the system and method without any security mechanism, and this does not impact the system's and method's performance outside of the security/privacy domain.

With particular reference to FIG. 1, a schematic view is provided of a transactive inquiry client and a transactive inquiry appliance. A transactive inquiry client 101 preferably consists of an application specific search collector 105 and a client communications manager 110. The application specific search collector (in this exemplary embodiment utilizing web-based searches) is preferably implemented as a browser plug-in (e.g., Gecko based systems, such as XUL/XUL Overlays/JavaScript; Internet Explorer systems, such as C/C++ Browser Helper Object). The browser plug-in hooks all incoming web documents and compares the URL's to a user defined and/or system defined list of interested search engine URL's and extracts through pattern matching the search terms used for the results given in the incoming web documents. More particularly, as mentioned briefly above, the search collector in the exemplary embodiment is hosted within a browser (as an extension, plug-in, or helper object using a suitable API for that specific browser), utilizing a browser based messaging API to access, or hook, the browser's message queue, ensuring that the search collector is notified when a new document is requested either through user interaction or browser-based automation. By API specification, the message the client search collector receives from the browser contains a reference to the HTML document requested which contains a reference to the Uniform Resource Locator (URL). For example, for Gecko based browsers the API call that hooks the message queue for new document notification is window.addEventListener( ) listening for the DOMContentLoaded message. The HTML document can be referenced from event message through the original Target member (event.originalTarget). The URL can be referenced from the HTML document through the location member (htmlDocument.location). To extract the user's search terms from a URL, in accordance with RFC2396 (which is incorporated herein by reference), using the appropriate browser API, the following sample URL (http://www.google.com/search?h1=en&q=URI+RFC&btnG=Google+Search) may be dissected into its component parts: Scheme (http), Authority (www.google.com), Path (search), and Query (h1=en&q=URI+RFC&btnG=Google+Search). For efficiency the Authority and Path portions are matched to Authority and Path columns in a user defined and/or system defined default table before spending the extra resources to parse the Query. If there is a match in those columns then the elements (token delimiter, key delimiter, query key, term delimiter) of the matching row are selected for use in parsing the Query to extract the search terms. The Query is then split into tokens based on the token delimiter (GOOGLE for example uses “&” making the resultant tokens “h1=en”, “q=URI+RFC”, “btnG=Google+Search”). The tokens are matched (via regular expression matching and/or byte-based matching) to the query key to determine query key resultant (GOOGLE uses “q” making the query key resultant “q=URI+RFC”). The query key resultant is stripped of the key delimiter leaving the aggregate search terms (“URI+RFC”). The aggregate search terms are split into singleton search terms based on the term delimiter (GOOGLE uses “+” making the resultant terms “URI” and “RFC”). This same process can be conducted a number of ways (to include different steps (more aggressive use of regular expressions), various combinations of current steps, and various combination of different steps and current steps).

Extracted search terms are associated with a time stamp of their arrival generated from the appropriate library call, the search engine 103 used generated from the given host name in the incoming web document URL, and the raw search string extracted from the search portion of the incoming web document URL to become a transactive inquiry client search event data record 106. The transactive inquiry client search event data record 106 is written to a file within the file system 107 owned by the currently logged in user 50 in a directory path associated with the transactive inquiry system and method and transactive inquiry events. Each transactive inquiry client search event data record is appended to that file.

As mentioned above, other applications (i.e., beyond web-based applications) may likewise extract their data in similar fashion, build a similar transactive inquiry client search event data record, and place it in the transactive inquiry events directory.

The transactive inquiry client search event data record 106 preferably comprises a timestamp, an identification of the search engine performing the search, and the extracted raw search data (i.e., the full query).

The transactive inquiry client communications manager 110 is preferably implemented in C/C++ as a user-run executable file, a system-run service, or a system-run daemon process (depending upon the execution environment and system installation permissions). The communication manager 110 monitors the files in the transactive inquiry events directory (on a multi-user system with appropriate permissions, every user's transactive inquiry events directory would preferably be examined), and either at a user defined polling period (managed by scheduled timers provided by the OS APD or when a change occurs that modifies the last modified time of a given file in the directory (also a polled event of higher frequency), the communication manager bundles the transactive inquiry client search event data records into a transactive inquiry client search event collection to be communicated to the transactive inquiry appliance 151 through an HTTP (or HTTPS) formatted POST (or file transfer upload) operation. The transactive inquiry client 101 then preferably shifts the data out of the transactive inquiry events directory into an archive directory available for further client side analysis, examination, correlation, and context determination.

The transactive inquiry client communications manager 110 also checks for inbound messages (relationships (as described above) identified between searches conducted by the user and other users in the system, updates, alerts, and software upgrades (Communications Manager or Collector)) to appropriately display to the user, such as through pop-up notifications or manager windows.

The transactive inquiry client communications manager 110 maintains the configuration information for handling communications including what transactive inquiry appliance 151 (and alternates and/or mechanisms to search for active transactive inquiry appliances capable of receiving the transactive inquiry client search event collection) to communicate with, periodicity of communication, authentication criteria, and other user defined data.

The transactive client search event collection preferably includes a timestamp, the system (i.e., client host) name, an identification of the user (and particularly the user's role or position in the structure of the organization in which the transactive inquiry system is deployed), and a list of transactive inquiry client search event data records included in the collection.

The transactive inquiry appliance 151 preferably comprises a communications manager 155, data store 157, data correlation mechanism 159, report generator 161, security manager 165, system administration manager 167, messaging system 163, and output device 169 for displaying information to an administrative applicance user as they interact with the appliance 151. As discussed in greater detail below, the appliance 151 is preferably capable of securely collecting information from a large number of transactive inquiry clients 101 (e.g., user name, search query, requests for previous searches, etc.), securely disseminating information to appropriate transactive inquiry clients 101 (e.g., contact notifications, previous searches), and securely disseminating information to appropriate transactive inquiry appliances 151 (e.g., reports). The transactive inquiry appliance hardware is preferably configured to require minimal effort at installation beyond IP assignment, and is configured to run continuously and auto-restart for soft shutdowns. Redundant power supplies and multiple hard drives are preferably provided.

The appliance communications manager 155 comprises managers handling client input, client notification, report transmission, report reception, report display, query request, query response, and other data (such as appliance and system status information, permissions and security information, etc.). Each communications manager may be implemented as a module within an application server framework. Each communications manager preferably has interfaces to allow basic system administration (start, stop, restart of module), basic access control and security (read/write/execute permissions), basic storage and retrieval from the data store, and basic publish and subscription with a messaging system. The core appliance communications manager 155 manages the primary web connection parsing received information and passing such information to the appropriate handler.

The appliance communication manager's client input handler receives transactive inquiry client search event collections from the locally managed transactive inquiry clients 101, after a properly authenticated connection request, and parses the information and places it in the data store 157. The client input handler also publishes a new data arrival message to the messaging system 163.

The appliance communication manager's client notification handler, when cued by the client input handler (or the new data message on the message system), marshals any awaiting messages for the connected client from the messaging system 163, and sends notification messages (search correlations, updates, alerts, and software upgrades) back as the response to the POST message (or file transfer upload) received.

The appliance communication manager's report transmission handler, when new report generated messages are published to the messaging system 163, sends collected reports out to the appropriately user configured sister and parent transactive inquiry appliances 151 via HTTP/HTTPS POST (or file transfer upload) protocol. For instance, the system may be deployed in an administrative hierarchy where the system administrators have elected to have, by way of example only, three levels within the hierarchy. The lowest level appliance serves as a query collection device, as described above, that collects queries from assigned users 50, obscures the user's identification data, and eventually serves as the access point for reports accessible to users. This level of device may thus, for instance, be deployed to various divisions and small to medium size departments within an organization. Further, these low level devices preferably do not communicate directly to other low level devices, but instead report to a middle level appliance. The middle level appliance in turn preferably aggregates data from the low level appliances distributed throughout an organization. Small organizations might only have lower level collection devices and middle level appliances, while larger organizations may have many lower level collection devices reporting to several middle level appliances which will in turn report to higher level appliances. The middle level appliance may serve as the data collation points for the lower level collection devices that report to it, and will house the report generation functions for all personnel within the affected divisions and departments. Last, the high level appliance will preferably house the organizational collation point, inter- and intra-organizational communications capability, and the management mechanism for all of the lower level appliances.

The appliance communication manager's report reception handler receives reports from sister and child transactive inquiry appliances and publishes the data to the data store 157 (or the messaging system 163 for further processing by subscribed components).

The appliance communication manager's report display handler publishes the most recent report to the viable standard browser. While viewing the most recent published report, the user is preferably able to select updated reports.

Last, the appliance communication manager's query request handler directs a query request to the appropriate sister/child, and the query response handler returns a query response to the appropriate originator through the parent, similar to a DNS for search queries.

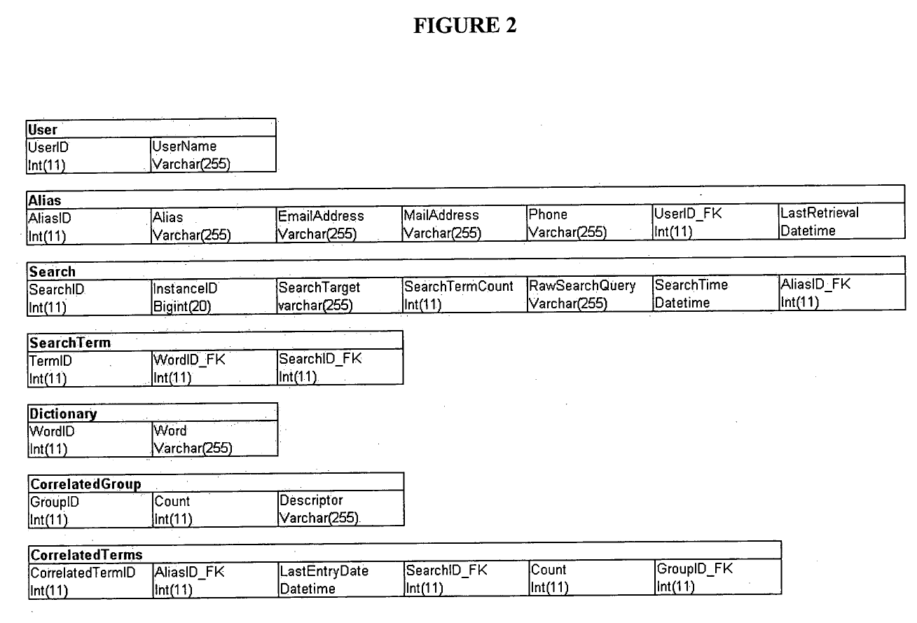

Next, the transactive inquiry appliance data store 157 comprises a database constructed of the appropriate tables, including data such as identification of users of the system, each such user's role within the structure of the organization (which role dictates the level of access such user has to information generated by the method and system herein described), and records of queries generated by each such user as detailed above. An exemplary representation of the relevant data fields is schematically shown in FIG. 2.

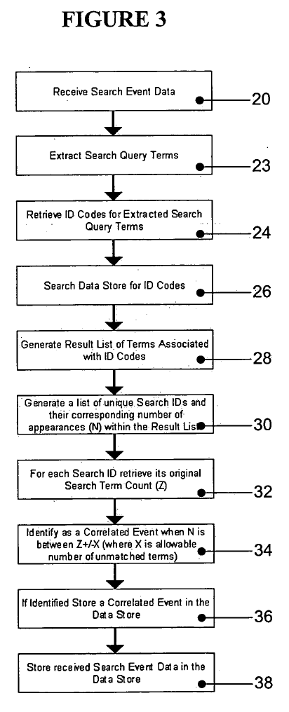

The transactive inquiry appliance data correlator 159 scans through the client search and report data stores 157 through Search Term with User ID (single word) and Search Term with User ID and Instance IDs (multi-word) using a greedy comparison approach looking for rows (or multi rows) that have similar search terms but differing user ids (or in place of user ids with the report data store appliance ids (or organization ids)). In the exemplary embodiment, for each search term within a query (containing 1 . . . N search terms) being inserted, the system returns all of the user-id (U)/instance-id (I) pairs for search terms (using byte-based matching) that do not contain the user-id of the inserted query, and are within the appropriate, pre-designated time period that is subject to analysis. Each search term will have a set of U-I results. The sets are concatenated together, the like U-I pairs are grouped and counted, and those U-I pairs that have a count greater than X (where X is equal to a user-defined percentage of N) are considered correlated. The search correlation notification is queued by the appliance communications manager 155. FIG. 3 is a schematic representation of the method carried out by search data correlator 159 in order to determine whether a correlation exists among queries of disparate users 50. More particularly, at step 20, data correlator 159 receives search event data records from a plurality of users 50 that have been transferred to appliance 151. At step 22, the search query terms are extracted from the received search event data records, and at step 24, an associated word ID, for example a numeric identification code, is retrieved for each extracted word from a library file in data store 157. Next, at step 26, data store 157 is searched for each word ID code identified in step 24, and at step 28 a result list is generated of all search ID codes associated with each such word ID code (i.e., a list is generated of all searches in which any of the words associated with the word ID codes appear). At step 30, the list from step 28 is concatenated into a list of all unique search ID codes and their corresponding number of appearances (N) within the list from step 28. At step 32, for each unique search ID code identified in the list from step 30, the original search term count (Z) is retrieved. Next, at step 34, events are deemed correlated when N falls between Z±X, where X is a predetermined maximum allowable number of unmatched terms between two queries. Next, at step 36, if a correlated event is identified, a record of such correlated event is saved in the data store. Last, at step 38, the search event data record is preferably likewise saved in the data store for additional, future searching purposes. Stored correlated events may thereafter be processed, either through automatic system polling or at the direction or instruction of an administrative user, to determine which, if any, of such correlated events reflect a system or administrative user-defined relationship, and generate an alert to the appropriate user indicating the existence of such transactive inquiry relationship.

The transactive inquiry appliance report generator 161 generates a new report when a new report generation message is published to the messaging system 163 (either by timed request from the system to support propagation to other transactive inquiry appliances 151 or when requested by the display handler). The report is constructed from the data stores of raw and correlated data, excluding and including appropriate information depending on permissions of the request message as well as the user defined focus lists.

The transactive inquiry appliance security manager 165 manages the authentication and permissions required to provide appropriate privacy/security.

The transactive inquiry appliance system administrator manager 167 allows configuration of the system parameters. More particularly, the system administrator 167 allows an administrative user to configure reporting times (e.g., how often to generate reports), reporting criteria (e.g., how many of X or Y or Z should be contained in a report), and general configuration information such as identification of self, reporting parent appliances, expected children devices/appliances, expected users, reporting sibling appliances, expected sibling appliances, and alternates to parent/sibling appliances (in the event that parent/sibling appliances are unreachable).

The transactive inquiry appliance messaging system 163 manages the inter-module communication receiving published messages and delivering them to appropriate subscribers (Topic or multiple Topics). The messaging system 163 logs all the messages for later analysis and troubleshooting. The messaging system 163 is also responsible for publishing notification for scheduled events that would be configured through the system administrator manager.

With regard to user interaction with the system, a system administrator may access functions of the system administration manager on a transactive inquiry appliance to: (i) easily install a transactive inquiry appliance on a network (preferably with minimal reconfiguration of security and/or policy access appliances, and minimal interaction with the transactive inquiry appliance operating system or shells); (ii) securely and remotely configure user roles and permissions, including managing user accounts (create/delete/edit), assigning functional permissions to the manager accounts, and assigning users (or user groups) to the manager accounts; (iii) securely and remotely examine the status of the transactive inquiry appliance, including display of connected nodes (for both users and managers), and performing system diagnostics and reporting; (iv) reboot the transactive inquiry appliance into a functional state, and (v) perform tasks of the manager end user. The tasks of the manager end user include: (i) securely and remotely configure policies, including user participation policy (forced or elected, included or excluded), transactive inquiry appliance interaction policy (passing reports to hierarchical superior and/or peer, passing contact notifications to hierarchical junior and/or peer, and passing information requests to hierarchical junior and/or peer), and report on examination policy; (ii) securely and remotely create, format, examine, and export reports, including the top X search subjects, new search subjects, low frequency-high interest searches, user associations (contact notification), and query report data (individual and aggregate); (iii) securely and remotely create and examine information requests, including information to fulfill report requirements; and (iv) securely and remotely receive and forward contact notifications, including viewing contact notifications generated by the system.

An individual user may likewise interact with a transactive inquiry client 101 to: (i) run a successful search query against any search engine without any noticeable interaction with the transactive inquiry client; (ii) configure participation within the system, including making an election to participate (or temporarily participate) in the system (assuming participation is not forced), designate a desire (or a temporary desire) for contact by specific groups of acquaintances/associates (assuming such designation is not forced), such as all, local, organizational, national, and/or external acquaintances/associates, designate contact information to be included (such as contact alias, phone number, email address, mail address, etc.), select times and frequencies for communication with the transactive inquiry appliance (such as at session start and close, every 15 minutes, every day, etc.), and display transactive inquiry client status; (iii) view previous searches made by the user while participating with transactive inquiry against a supported search engine; (iv) receive appropriate contact notifications; and (v) install the client (if not already installed) through appropriate browser extension installation mechanisms.

In use, a basic user of the system is typically an individual user within a structured organization whose role within the organization, i.e., job role, function, or title, is at a lower level within the structure or hierarchy of the organization than that of intended administrative users (or “managers”) of the system. The system may identify correlations between search queries of users at this respective lower level within the organization and other users of the system (and/or subjects of interest to the organization), whether at the same or higher, and possibly, lower, levels within the organization. Likewise, an administrative user (or manager) of the system is a third party distinct from two users whose search queries are examined for correlation, and is typically an individual user within the organization whose position or role is at a higher level within the hierarchy than that of at least one of the users whose query is undergoing the correlation analysis, or in a role providing such administrative user with oversight of the search activities of such other users.

The basic user's interaction with the system principally generates the data which the system processes to identify correlations between and among disparate users' search queries (although higher-level administrative users may optionally also generate queries that will be processed by the system). However, the correlation system preferably remains hidden from that basic user, at least to the extent so as to not interfere with the basic user's normal operation of their automated search tools. Thus, by way of non-limiting example, if a basic user is searching for information in a commercial web browser, then that user's interaction with such commercial browser continues as normal while the system (i.e., the client search collector 105) gathers the relevant data from that user's searching activity.

An administrative user's or manager's interaction with the system allows for management of other users (including, for example, adding and deleting new basic and administrative users, defining and modifying permissions for such users as described below, etc.), generation and review of reports and alerts, and adjustment of general system settings. As only certain members within the organization will likely be intended to have authority to make such decisions, an administrative user's access to the system is preferably secure, preferably requiring at least username and password access or other protections as are known in the art to ensure that such user is, in fact, an authorized administrative user.

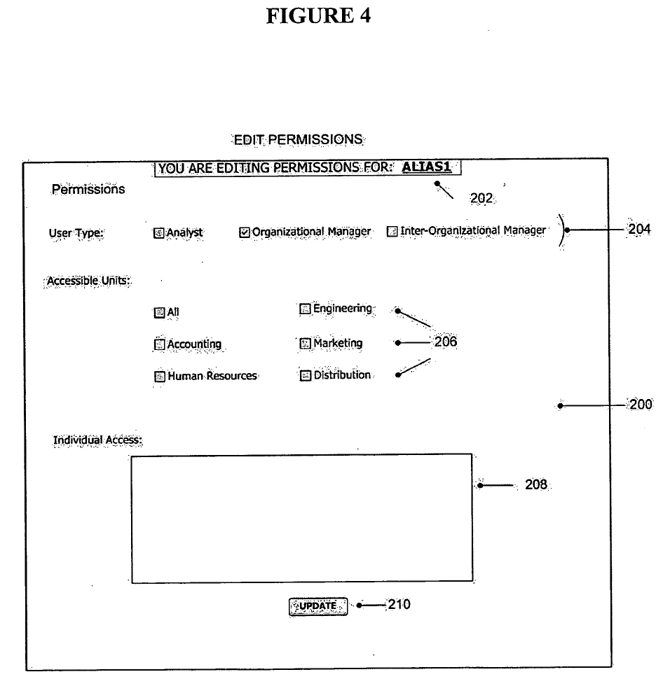

FIG. 4 is an exemplary user interface screen 200 that may be presented to an administrative user to allow such user to modify the permissions of other users of the system. Such permissions are typically determined by the user's own role, job function, or other position within their respective organization, and define the organizational units within the organization that such user may access to in turn access, review, and generate reports based on search queries by members of such organizational units. A user identification field 202 provides the administrative user an indication of which user record they have current access to. A user role selection field 204 allows the administrative user to designate the subject user's role within the structure of the organization. In the exemplary screen 200 of FIG. 2, a three-level hierarchy is provided, and the administrative user may select which level properly includes the subject user. More or fewer hierarchical levels., and thus selections, may be provided to accommodate the particular organizational structure concerned. Each such level may have a pre-defined permissions profile. For instance, a first tier user (e.g., “Analyst”) may be restricted from accessing any search queries of any users other than their own. A mid-tier user (e.g., “Organization Manager”) may have access to queries generated by first-tier users within the organizational unit or units that they supervise or-control, such that the mid-tier user may become aware of correlations among search queries by those first-tier users. A top-tier user (e.g., “Inter-Organization Manager”) may have access to queries generated by mid-tier users and first-tier users below that mid-tier user, such that the top-tier user may become aware of correlations among search queries by users in a larger segment of the organization.

As security concerns or goals may require that users in particular tiers have limited access to other tiers, the level of access provided at each tier is preferably customizable. Thus, for example, in a given organizational hierarchy, the first-tier users might have access to only their own search query history, or might even have no access to the system functions at all (other than automatically having their search queries forwarded to the system for correlation processing). Alternatively, certain first-tier users might in some organizations benefit from knowledge of correlations of their search activity with that of others in the organization, in which case that user may be given permission to access the query history and queries of other users at the same level. Likewise, mid-tier users might, for example, have access only to the queries of first tier users below them in the hierarchy of the organization, or possibly to queries of users in other segments of the organization. Top-tier users preferably have access to queries of users at all levels in the organization. However, it may be desirable to (in order to maintain confidentiality as required by business objectives), for instance, limit the access of all top-tier users to only the query information available to users directly below them in the hierarchy (in this exemplary case, mid-tier or “Organizational Manager” users), and all mid-tier users to have access only to the query information of users directly below them in the hierarchy, etc. Thus, for instance, a top-tier, Inter-Organization Manager may learn from a mid-tier Organization Manager's query data that an unknown first-tier user's query correlates with the query of a first-tier user in an entirely distinct segment of the organization, but might not be aware of which particular segments under each Organizational Manager produced such queries. In such circumstance, in order to make use of such correlation knowledge (e.g., have the particular first-tier users corroborate with one another in their search efforts), the top-tier user would have to work through the mid-tier users to identify the particular first-tier users that produced the correlating queries.

In order to allow for such customizable permissions for each user, an administrative user may make selections of individual organizational segments or units within the organization using organizational unit selection field 206. By selecting one or more fields in organizational unit selection field 206, such user may be provided access to query data generated by users in that particular unit of the organization. Preferably, the administrative user may also designate specific users in the organization by listing individual user ID's in individual designation field 208, thus additionally providing the respective user 202 with access to the query data generated by specific individual users regardless of their location, role, or job function within the organization. Once the administrative user has made the desired changes, they may initiate an UPDATE function 210 to save the changes to the user 202's profile, and the system may generate a notice, such as an email message, instant message, or the like, to the user 202 (and optionally any users above user 202 in the organization's hierarchy) to inform them of the changes that were made.

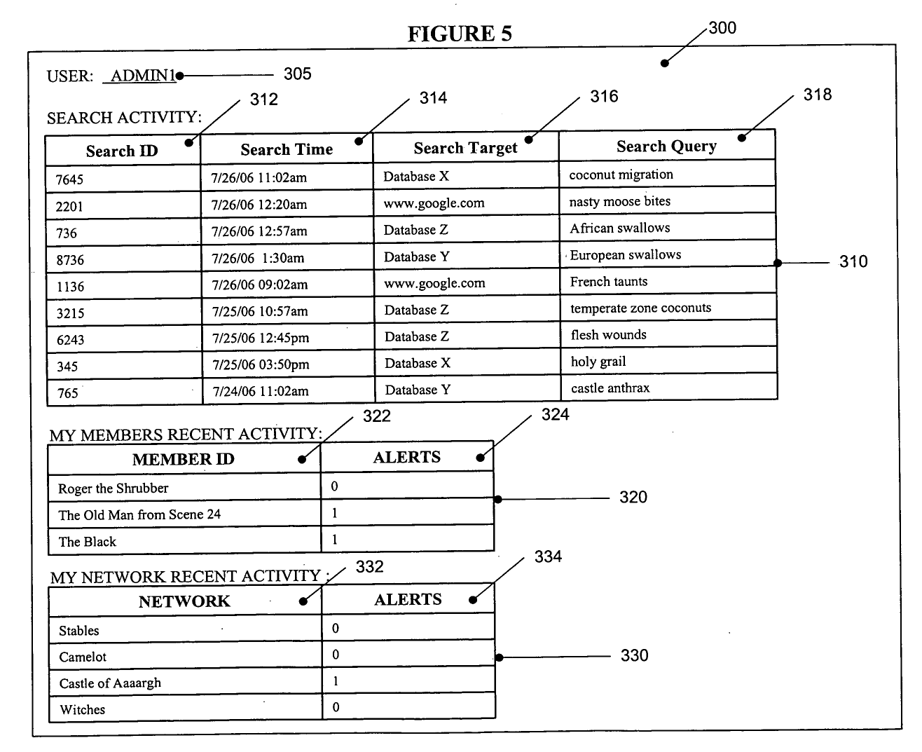

FIG. 5 is an exemplary “control center” user interface screen 300 that may be presented to a user to allow them to access and control various functions and data for reviewing, managing, and reporting on correlations. User interface screen 300 may optionally provide an indication of the particular user whose control center is displayed, such as at user identification field 305. Preferably, control center screen 300 includes a search history report 310 that details the recent search activity of the particular user. Search history report 310 may provide a search ID 312 for each search, the time stamp data 314 for each search, an indication of what program 316 against which the particular query was run, and the specific query 318. Control center screen 300 also preferably provides a member activity report 320 that preferably provides a listing of member ID's 322 listing those individual users within user 305's organizational unit, i.e., those users that are directly below user 305 in the organizational hierarchy and/or whose queries are intended to be reviewed and/or accessed for correlation identification by user 305. For each such member 322, a link 324 (such as a hyperlink) is preferably provided to a listing of alerts for that member's searching activity. An alert, as used herein, is preferably an indication of a correlation between two users' queries or one or more users' queries and a subject of interest to the organization, as described in detail above. For instance, and by way of non-limiting example, user 305 may have indicated that searches for “discrimination” by users in the human resources department are high interest and should generate an alert. Thus, for any members in the human resources department that initiate such a query, an alert will be generated and linked through alert field 324. Likewise, user 305 may have indicated that searches for “flight training” and “terrorist” by distinct users in any unit of the organization warrant generating an alert. Alternatively, a library of “high interest” or other terms may be provided causing an alert to be generated when a user's query includes any such terms without requiring the specific designation of such by a user. Thus, for any members in user 305's member listing that have generated such a query, and that query correlates with another user's query in the organization, an alert 324 may be indicated for such member 322. The alert may, for instance, indicate that a correlating query was generated by a particular user (providing the user ID of such other user), or may provide only an identification of such other user's unit within the organization, thus requiring user 305 to initiate contact with the manager of such unit in order to further pursue any action in response to finding the correlation.

Likewise, a network activity report 330 may be provided that preferably provides a listing of units 332 within the organization from whom user 305 may access query data. As with member activity report 320, network activity report 330 preferably provides a link 334 to a listing of alerts for that unit's searching activity.

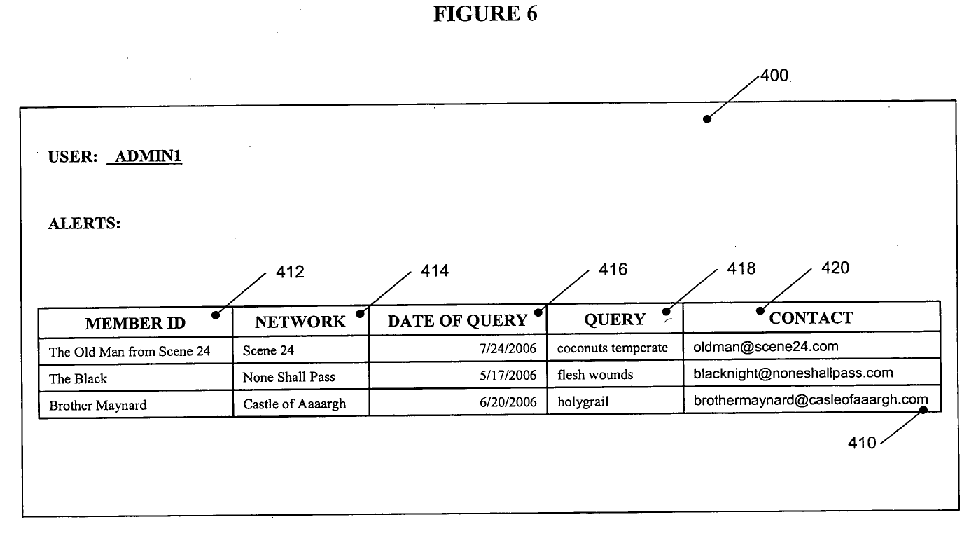

Upon selection of an alert link (324 or 334), user 305 is preferably presented an alert screen 400 as schematically represented in FIG. 6, which provides user 305 an alert report 410. Alert report 410 preferably lists, for each alert generated, a member ID 412 for the individual whose search query contributed to generation of the alert, the unit 414 to which such individual user belongs in the organization, the date 416 on which such query was generated, the query 418, and the contact information 420 associated with such member ID 412. As security may require that certain individuals using the system not be made aware of the identity of other users of the system, the member ID 412 (and the same field on other screens) may comprise an alias for the actual user so as to mask their identity. Thus, contact 420 associated with a particular member ID 412 may be member ID 412's true contact information, may alternately be contact information for someone above such member ID 412 in the organization, or may be left blank, requiring user 305 to contact an administrative user in the particular unit 414 in order to follow up on an alert.

As explained above, a variety of transactive inquiry relationships may be customized by a user. In particular, transactive inquiry relationships may be used to define the level of query correlation that will generate an alert. For instance, a user may designate a top queries alert by defining a threshold percentage or other metric of users within a unit generating similar search queries, such that an alert is generated when such threshold is exceeded. Likewise a user may designate a novel query alert by defining a unique search query term and time period, such that an alert is generated if a user enters such unique search query within that time period. Further, a user may designate a trend alert by defining a time period and one or more search query terms of users within their particular unit in the organization, such that an alert may be generated showing a trend on such query terms, when their usage exceeds a threshold level within the defined time period. Likewise, wave alerts may be generated by defining a time period and one or more search query terms of users throughout the organization, such that an alert may be generated showing an organization-wide trend on such query terms when their usage exceeds a threshold level within the defined time period. Further, a user may designate a high frequency alert by defining a time period and a number of matches between identical or similar search query terms, such that an alert may be generated when any query term is used more than the designated number of matches in the defined time period. Optionally, such high frequency alerts may also designate whether such high frequency terms are of high interest, low interest, or undefined interest level depending upon an interest level assigned to specific search terms by the user receiving the alerts. Similarly, a user may designate a low frequency alert by defining a time period and a number of matches between identical or similar search query terms, such that an alert may be generated when any query term is used less than the designated number of matches in the defined time period. Optionally again, such low frequency alerts may designate whether such low frequency terms are of high interest, low interest, or undefined interest level depending upon an interest level assigned to specific search terms by the user receiving the alerts. Still further, a user may designate a deep search alert by defining a threshold number of search sources (e.g., Internet web browser, database program SEARCH function, word processing document FIND function, etc.) such that an alert is generated when a user performs a search using identical or similar search queries in a number of search sources equal to or exceeding the threshold number.

As used above, a “similar search query” is intended to refer to a search query term that is either (i) textually or phonetically similar in an effort to, for example, capture misspelled terms, plurals, etc., or (ii) contextually similar, such as words that are synonyms or otherwise conceptually linked, such as “plane,” “airline,” and “747.” A list of synonymous terms may be generated by individual knowledge experts and/or by commercially available dictionary and thesaurus services.

Also, while various alert messages have been detailed above, it should be recognizable to those of ordinary skill in the art that a user may also preferably engage a reporting function at any time in order to generate a report of any of the foregoing query-defined relationships. Optionally, users may also have the ability to block the visibility of any particular search.

Further, while the general example described above references a hierarchical organization in the form of a structured business entity, it should likewise be recognizable to those of ordinary skill in the art that the invention may be applied to much more disperse organizations or networks. By way of non-limiting example, the invention may be applied to a loosely structured flat organization such as networks of affiliated hospitals, with each such hospital applying the invention in order to enhance internal performance in meeting each such hospital's business objectives. Simultaneously, those hospitals may be members of an ad hoc hierarchical organization with a national entity, such as the CDC, at the top of such hierarchy which could focus data correlation on the detection of national pathogens, such as the flu, small pox outbreak, or novel biological attack. Because the aggregated queries of the individual doctors would be the triggering event for an alert, such a use of the invention could produce an awareness of the nature and scope of the outbreak before the individual doctors or medical system would even be aware of what they were seeing.

Having now fully set forth the preferred embodiments and certain modifications of the concept underlying the present invention, various other embodiments as well as certain variations and modifications of the embodiments herein shown and described will obviously occur to those skilled in the art upon becoming familiar with said underlying concept. It should be understood, therefore, that the invention may be practiced otherwise than as specifically set forth herein.

1. A method of identifying correlations among search queries by disparate users within a structured organization, comprising the steps of:
(a) receiving from a first user data identifying said user and at least one query generated by said user;
(b) comparing said query of said first user with at least one search term of interest to determine whether a predefined organization-specific relationship exists between said query and said search term of interest; and
(c) if a predefined organization-specific relationship exists, notifying a third party user distinct from said first user of the existence of said relationship.

2. The method of claim 1, wherein said at least one search term of interest further comprises a query generated by at least one second user.

3. The method of claim 2, said step of comparing said query further comprising:
(i) identifying all first user query search terms in said query received from said first user;
(ii) searching a data collection for occurrences of query search terms that are similar or identical to said first user query search terms, wherein said data collection further comprises data records comprising second user query search terms and data identifying said second user; and
(iii) determining whether said predefined organization-specific relationship exists between similar or identical first user and second user query search terms located in said searching step.

4. The method of claim 3, said determining step further comprising determining whether said first user and second user query search terms fulfill a query relationship profile that has been selected by said third party user.

5. The method of claim 1, wherein said data identifying said user further comprises data identifying said user's role within the structure of said organization.

6. The method of claim 5, wherein said step of notifying a third party user further comprises disclosing a level of detail of information that is determined by said third party user's role within the structure of said organization.

7. The method of claim 6, wherein said level of detail is determined by an administrative user authorized to designate collections of users whose queries may be accessed by said third party user.

8. The method of claim 1, wherein said query comprises a search query entered by said user in a web browser application.

9. The method of claim 1, wherein said query comprises a search query entered by said user in a computer software application having a search function capable of initiating a search of electronic data.

10. The method of claim 1, wherein said method of identification of predefined organization-specific relationships is carried out without interaction from said user other than input of said search query.

11. A system for identifying and reporting correlations among search queries by disparate users within a structured organization, said system comprising:
a plurality of search event data records from a plurality of search users stored in at least one database, said search event data records further comprising a timestamp, one or more query search terms, and an identification of the search user generating said query search terms;
one or more search user client devices in data communication with said database configured to transfer search event data records to said database; and
a computer processor in data communication with said one or more search user client devices and said database, said computer processor having executable computer code adapted to:
(a) provide a user interface allowing an administrative user access to said search event data records in said database;
(b) compare a plurality of search event data records in said database to determine whether a predefined organization-specific relationship exists between query search terms in said plurality of search event data records, and generate an electronic notification of the existence of any predefined organization-specific relationships determined to exist; and
(c) forward said electronic notification to one or more administrative users, wherein said electronic notification is customized for said administrative user based upon a role of said administrative user within said structured organization.

12. The system of claim 11, wherein each said search user client device further comprises a search collector module having executable computer code adapted to collect a search user's search query data, a timestamp indicating a time at which said search user generated said search query data, and an identification of said search user.

13. The system of claim 12, wherein said identification of said search user includes an identification of said search user's role with said structured organization.

14. The system of claim 12, wherein collection of said search user's search query data proceeds without interaction from said user other than input of said search query data.

15. The system of claim 12, said computer processor further having computer executable code adapted to receive search event data records from said search collection modules of a plurality of search user client devices.

16. The system of claim 11, said computer processor further comprising executable computer code adapted to:
(d) present a user interface screen to said administrative user configured to solicit designations of another user's access to search event data records.

17. The system of claim 16, wherein said designation is made based upon said other user's role within said structured organization.
